(19) United States
(12) Patent Application Publication
(10) Pub. No.: US 2012/0118955 A1
(43) Pub. Date: May 17, 2012

(54) Electronic sight for firearm, and method of operating same

(75) Inventors: Phillip A. Cox, Highland Village, TX (US); James M. Florence, Dallas, TX (US)

(73) Assignee: Raytheon Company, Waltham, MA (US)

(21) Appl. No.: 11/732,573

(22) Filed: Apr. 4, 2007

Related U.S. Application Data
(62) Division of application No. 10/862,217, filed on Jun. 7, 2004, now abandoned.

(51) Int. Cl. G06G 7/80

(52) U.S. Cl. 235/404

(57) ABSTRACT

A firearm sight receives information regarding a factor, and then automatically adjusts the relative positions of a digital reticle and an image on a viewing section to compensate for the influence of the factor on a projectile trajectory. A different feature involves automatically adjusting a characteristic of the reticle based on the image. Another feature involves automatically adjusting the digital image to distinguish a portion thereof aligned with the reticle from an adjacent portion thereof. Yet another feature involves causing the firearm sight to generate an audible sound. Still another feature involves presenting information on the viewing section which represents the position of the firearm sight on the surface of the earth.

### TECHNICAL FIELD OF THE INVENTION

This invention relates in general to a device which facilitates accurate aiming of a firearm and, more particularly, to a firearm sight which is mounted on the firearm, and through which a user observes a potential target.

### BACKGROUND OF THE INVENTION

Over the years, various techniques and devices have been developed to help a person accurately aim a firearm, such as a rifle or target pistol. One common approach is to mount on the firearm's barrel a sight or scope, through which the person views the intended target in association with a reticle, often with a degree of magnification. Although existing firearm sights have been generally adequate for their intended purposes, they have not been satisfactory in all respects.

For example, when a sight is first mounted on the barrel of a firearm, it needs to be aligned or “zeroed” with the firearm barrel, typically through a trial and error process. For example, a person may shoot one or more bullets at a target which is a known distance away, identify the extent to which the bullets strike the target at locations offset from the location at which the person was aiming, and then adjust the alignment of the sight in relation to the firearm in a manner intended to eliminate the offset. This sequence of steps is repeated in an iterative manner, until bullets are striking the target at substantially the same location where the person is aiming.

This process results in alignment of the sight and firearm for one specific set of conditions. However, during subsequent use of the firearm and sight, for example when hunting, a variety of conditions can vary from the conditions that existed during the alignment or zeroing process, and can thus affect the trajectory of a bullet. These include factors such as temperature, pressure, humidity, wind speed and wind direction, all of which affect the density of air and thus the drag exerted on the bullet, and drag in turn influences the trajectory. Further, the tilt of the firearm barrel can influence the direction in which gravity acts on the bullet in relation to the initial trajectory of the bullet, and this can in turn influence how gravity affects the overall trajectory of the bullet. Still another factor is that the actual range or distance to a target is usually different from the range or distance that exists during the alignment or zeroing process.

Consequently, even after a sight has been aligned with respect to a firearm under known conditions, a person who thereafter, uses the sight to aim the firearm under other conditions needs to make appropriate mental and visual compensation. In this regard, the person must typically aim the reticle of the sight at a point which is offset from the desired impact point of the bullet on the target. For example, if the range to the target is much longer than the range used to zero the sight, the person may need to aim the reticle of the sight at a point which is located above the target. Similarly, if there is wind blowing from the left or right, the person may need to aim the reticle of the sight at a point which is offset leftwardly or rightwardly from the target, in order to compensate for the effect which the wind will have on the trajectory of the bullet. Some reticles include markings at known angular increments, to help a person make an appropriate offset, but there is still a high degree of mental guesswork involved.

Some persons may adjust knobs on the sight in order to adjust the alignment of the sight away from its initial setting, so as to compensate for the current conditions. Several different tables of data may be needed to determine appropriate adjustments for respective different factors, and the values from these multiple tables must be combined in order to determine a number of turns to be effected for each of two or more knobs. But this approach is complex, cumbersome and slow, and thus impractical for most real-world situations. For example, animal targets do not usually wait around while a hunter goes through this adjustment process. Moreover, even this approach usually involves a significant degree of mental guesswork as to what the current conditions are.

Given the variety of different factors that can influence the trajectory of a bullet, attempts of this type to mentally and visually effect compensation involve a significant degree of estimation and guesswork, and frequently result in the bullet missing the target altogether, or hitting the target at a location which is spaced from the desired impact point. A further problem is that, at any given point in time, existing sights use a selected reticle which has various predetermined characteristics, such as color, shape, size and/or brightness. Thus, for example, if the reticle is a dark color and the target also happens to be a dark color, it may be very difficult to distinguish the reticle from the target when the reticle is aligned with the target.

Still another consideration is that, when looking through an existing sight, it is sometimes difficult to identify and/or distinguish a potential target from other portions of the scene being viewed through the sight. Yet another factor is that a hunter or other person using a firearm and sight often has to carry other separate items of equipment. Examples include paper maps, compasses, laser rangefinders, self-contained global positioning system (GPS) devices, and several game calls designed to attract various different types of animals that are potential targets.

### SUMMARY OF THE INVENTION

From the foregoing it may be appreciated that a need has arisen for a firearm sight which avoids some or all of the disadvantages that are associated with pre-existing sights.

One form of the invention relates to operation of a firearm sight, and involves: providing on a viewing section an image of a scene in association with a digital reticle; receiving information representing a factor that can influence a projectile trajectory; and automatically adjusting a position of the digital reticle in relation to the image as presented on the viewing section so as to compensate for the extent, to which the factor would influence a projectile trajectory.

A different form of the invention involves: presenting for a user on a viewing section an image of a scene in association with a digital reticle; and automatically adjusting a characteristic of the reticle in response to the image.

Another form of the invention involves: presenting for a user on a viewing section a digital image of a scene in association with a reticle; and automatically adjusting the digital image to distinguish a first portion of the image which is substantially aligned with the reticle from a second portion of the image which is adjacent the first portion thereof.

Yet another form of the invention involves generating of an audible sound from a firearm sight.

Still another form of the invention relates to operation of a firearm sight having a display, and involves: receiving electromagnetic signals; determining in response to the received electromagnetic signals a position of the firearm sight on the surface of the earth; and presenting information on the display which represents the position of the firearm sight on the surface of the earth.

### BRIEF DESCRIPTION OF THE DRAWINGS

A better understanding of the present invention will be realized from the detailed description which follows, taken in conjunction with the accompanying drawings, in which:

FIG. 1 is a diagrammatic perspective view of an apparatus which is a digital rifle sight, and which embodies aspects of the present invention;

FIG. 2 is a diagrammatic fragmentary perspective view which shows an opposite side of the rifle sight of FIG. 1;

FIG. 3 is a diagrammatic view of a switch panel of the rifle sight of FIG. 1, in an enlarged scale;

FIG. 4 is a block diagram of the rifle sight of FIG. 1, and shows certain portions thereof which are not visible in the views of FIGS. 1-3;

FIG. 5 is a diagrammatic view of a color display which is a component of the rifle sight of FIG. 1, during a normal operational mode;

FIG. 6 is a diagrammatic view of the display during a menu mode, and shows a list of menu selections;

FIG. 7 is a diagrammatic view of the display, showing a reticle selection screen;

FIG. 8 is a diagrammatic view of the display, showing a screen used to set elevation and windage offsets for a currently-selected reticle;

FIG. 9 is a diagrammatic view of the display, in a mode used to display images and/or video clips stored within a memory of the rifle sight;

FIG. 10 is a diagrammatic view of the display, showing an options menu;

FIG. 11 is a diagrammatic view showing an entire image detected by an image detector of the rifle sight, and showing a portion of this image which is currently being presented on the display;

FIG. 12 is a diagrammatic view similar to FIG. 11, but showing how the sight has automatically shifted the displayed image relative to the detected image so that the reticle indicates the expected impact point of a bullet within the detected scene;

FIG. 13 is a diagrammatic view similar to FIG. 12, but showing the reticle centered on the target;

FIG. 14 is a diagrammatic view showing the detected image and the displayed portion of this image, under circumstances where the rifle and sight are tilted a few degrees about a longitudinal axis, and when an automatic ballistic compensation feature is disabled;

FIG. 15 is a diagrammatic view similar to FIG. 14, but showing how the sight has automatically repositioned the displayed portion of the detected image so that the reticle is centered over the expected impact point; and

FIG. 16 is a diagrammatic view similar to FIG. 15, but showing how a user has centered the adjusted reticle on the target.

### DETAILED DESCRIPTION

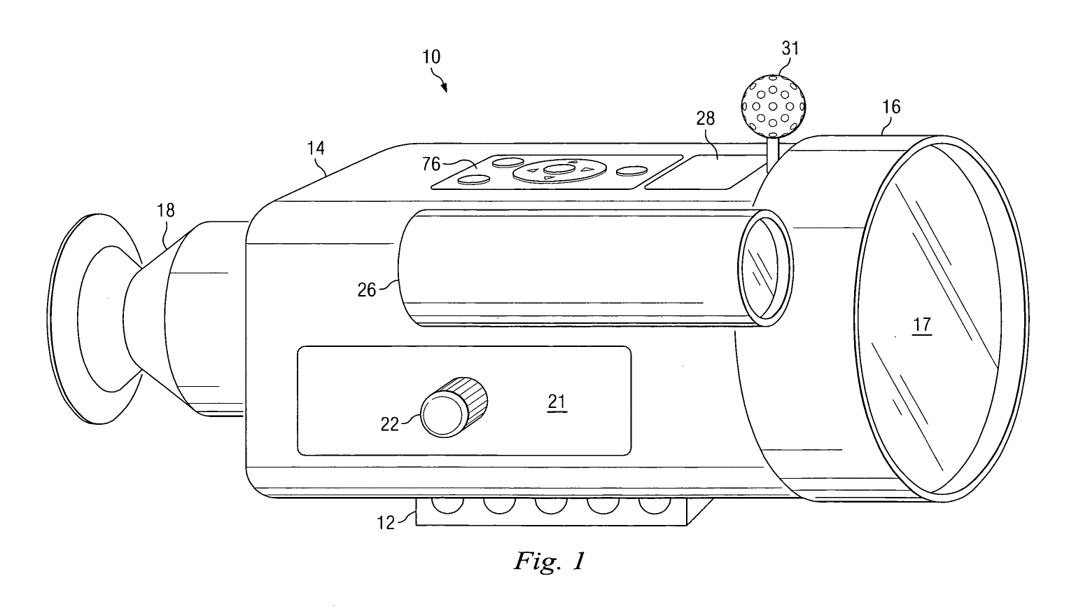

FIG. 1 is a diagrammatic perspective view of an apparatus which is a digital rifle sight 10, and which embodies aspects of the present invention. Although the sight 10 is referred to herein as a “rifle sight”, it can actually be used not only with rifles, but also with other types of firearms, such as target pistols. The sight 10 includes a rail mount 12, which can fixedly and securely mount the sight 10 on the receiver or mounting rail of a firearm.

The sight 10 includes a housing 14, which has at a front end thereof an objective lens section 16 that includes at least one lens 17, and which has at a rear end thereof an eyepiece optics section 18. The housing 14 has an access panel 21, which is removably held in place by a thumbscrew 22. The access panel 21 can be removed in order to provide access to an internal compartment that contains selected components, as discussed in more detail later.

The sight 10 has a laser rangefinder 26, which is fixedly mounted on one side thereof. The rangefinder 26 uses technology of a known type, and can determine the distance to a target by transmitting a laser beam and then analyzing reflected energy. A global positioning system (GPS) antenna 28 is provided on top of the housing 14, so that the sight 10 can receive electromagnetic GPS signals of a known type emitted by GPS satellites. Using these received GPS signals, the sight 10 can determine in a known manner its precise location on the surface of the earth, to an accuracy within a few feet.

A wind sensor 31 of a known type is mounted on top of the housing 14 of the sight 10. The wind sensor 31 has a spherical shell with a plurality of spaced openings through it, and has a sensor arrangement disposed within the shell. The wind sensor 31 is capable of detecting both the speed and the direction of any ambient wind. In the disclosed embodiment, the wind sensor 31 is a component which can be obtained commercially under the tradename OMNIPROBE from Aeroprobe Corporation of Blacksburg, Va. However, the wind sensor could alternatively be implemented with any other suitable device.

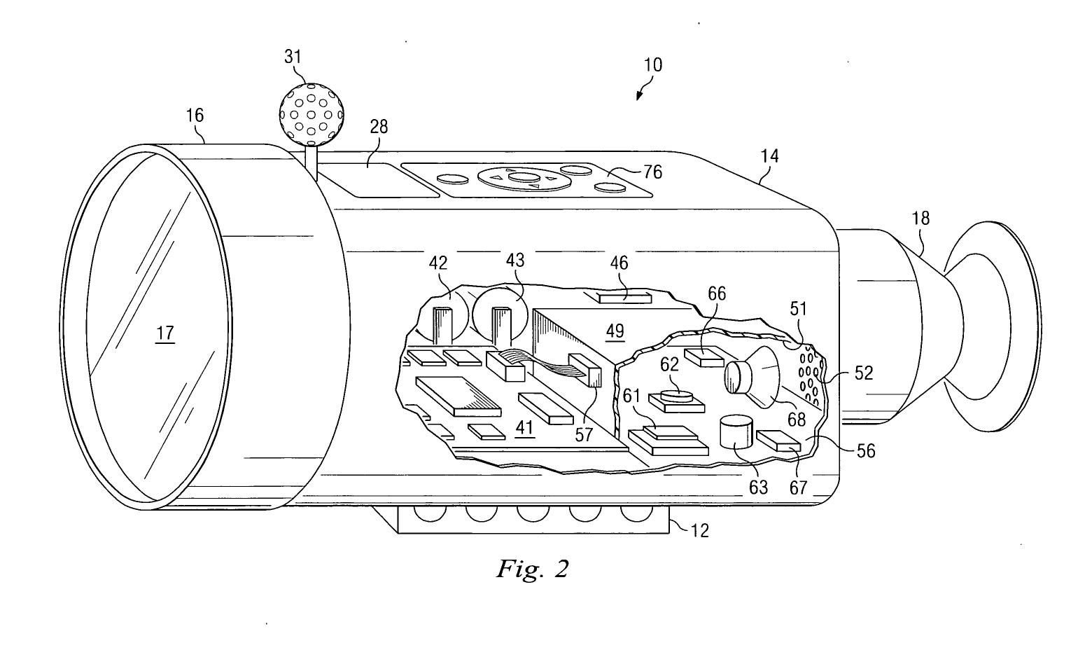

FIG. 2 is a diagrammatic fragmentary perspective view which shows an opposite side of the rifle sight 10 of FIG. 1. The sight 10 has some circuitry within the housing 14, including a circuit board 41. Two removable batteries 42 and 43 of a commercially available type are provided to power the circuitry. The access panel 21 (FIG. 1) can be removed in order to obtain access to the batteries 42 and 43 so that they can be replaced. Although the batteries 42 and 43 in the disclosed embodiment are replaceable, it would alternatively be possible to use rechargeable batteries.

As shown diagrammatically in FIG. 2, the sight 10 includes a removable memory card 46. In the disclosed embodiment, the memory card 46 is a memory card of the type commonly used in digital camera, for example an industry-standard card of the type commonly referred to as a Multi-Media Card (MMC) or a Secure Digital (SD) card. However, it would alternatively be possible to use any other suitable device for the removable memory card 46. The access panel 21 (FIG. 1) can be removed in order to obtain access to the memory card 46, so that it can be replaced.

The housing 14 includes a wall structure 49, which separates a portion of the interior of the housing 14 from the remainder of the interior. In particular, the wall structure 49 defines a compartment 51, which is a part of the interior of the housing 14 that is sealed off from the remainder of the interior of the housing. The housing 14 has a wall portion at the rear end thereof with a cluster of small openings 52 extending through it, in order to provide fluid communication between the interior of the compartment 51 and the ambient atmosphere surrounding the sight 10.

A further circuit board 56 is provided within the compartment 51, and is electrically coupled to the circuit board 41 through the wall 49 by a connector 57. The circuitry on the circuit board 56 includes a tilt sensor 61, which can detect the degree of tilt or roll of the sight 10 about the longitudinal axis of the sight 10, and also the degree of tilt or pitch of the sight 10 about a horizontal axis extending transversely to the longitudinal axis. In the disclosed embodiment, the tilt sensor 61 is implemented with a component that is available commercially as part number ADXL203 from Analog Devices, Inca of Norwood, Mass. However, the tilt sensor 61 could alternatively be implemented with any other suitable device.

The circuitry on the circuit board 56 also includes a pressure sensor 62, which can sense the ambient barometric pressure in the vicinity of the sight 10. In the disclosed embodiment, the pressure sensor 62 is implemented with a commercially available part, which is an MPX4115A/MPXA4115A-series device available from Motorola Inc. of Schaumburg, Ill. However, the pressure sensor 62 could alternatively be implemented with any other suitable device.

The circuitry on the circuit board 52 further includes a sensor 63, which can detect the ambient temperature and the ambient humidity in the vicinity of the sight 10. In the disclosed embodiment, the temperature and humidity sensor 63 is implemented with a device which is available commercially as part number HIH-3602-C from the Sensing and Control division of Honeywell, Inc. in Freeport, Ill.

A further component of the circuitry on the circuit board 56 is an accelerometer 66. In the disclosed embodiment, the accelerometer 66 is a device which can be obtained commercially as part number ADXL105 from Analog Devices, Inc. However, the accelerometer 66 could alternatively be implemented with any other suitable device. The accelerometer 66 is a highly sensitive sensor that can detect the relatively small shock wave which occurs when the firing pin strikes a cartridge within a firearm on which the sight 10 is mounted. Of course, when the firing pin strikes the cartridge, it triggers combustion of the gun powder or other propellant disposed within the cartridge, so as to expel a bullet or other projectile from the cartridge and the firearm.

When the firing pin strikes a cartridge, the output from the accelerometer 66 has a frequency spectrum which is different from the frequency spectrum produced in response to combustion of the material within the cartridge. Consequently, the circuitry in the sight 10 can distinguish a shock wave representing the firing pin striking a cartridge from a different shock wave representing some other type of event, such as combustion within a cartridge.

The combustion within a cartridge produces a shock wave or recoil which is many orders of magnitude larger than the shock wave produced when the firing pin strikes the cartridge. The accelerometer 66 has the sensitivity and bandwidth needed to detect the relatively small shock wave which is produced when the firing pin strikes a cartridge, and also has the durability needed to withstand the much larger shock wave or recoil which is produced by the ensuing combustion within the cartridge.

The circuitry on the circuit board 56 further includes a gyroscope 67, which is referred to here as a rate gyro. In the disclosed embodiment, the rate gyro 67 is implemented with a pair of known devices, which are each available commercially as part number ADXRS150 from Analog Devices, Inc. However, it would be alternatively be possible to implement the rate gyro 67 with any other suitable device. The two ADXRS150 parts are oriented so that one is orthogonal to the other, such that these parts detect angular movement about respective vertical and horizontal axes. Consequently, the rate gyro 67 is capable of detecting the rate of angular movement of the sight 10 about a not-illustrated vertical axis and a not-illustrated horizontal axis. Stated differently, the rate gyro 67 is a highly sensitive device which is effectively capable of detecting the rate of movement of the sight 10 in directions transverse to a not-illustrated center line of the objective lens section 16.

A small loudspeaker 68 is supported on the circuit board 56, in proximity to the openings 52 through the housing 14. The circuitry within the sight 10 is capable of using the speaker 68 to emit through the opening 52 a selected audio sound, such as an animal sound of a type which is commonly known as a game call, and which is intended to attract a prospective target to a hunter who is using the sight 10.

Although the disclosed embodiment uses the speaker within the housing 14, it would alternatively be possible to use a larger speaker disposed externally of the housing 14, in order to permit a louder sound to be emitted, so that the sound will travel a longer distance. In this regard, a larger speaker could be provided in a further housing which is external to and separate from the housing 14, and which is coupled by wires to a not-illustrated connector provided somewhere on the housing 14, for example within the compartment behind the access panel 21 (FIG. 1). Where a speaker is provided within such an external housing, it would also be possible to provide a battery-operated amplifier within the same housing, in order to amplify the audio signals before they are supplied to the speaker.

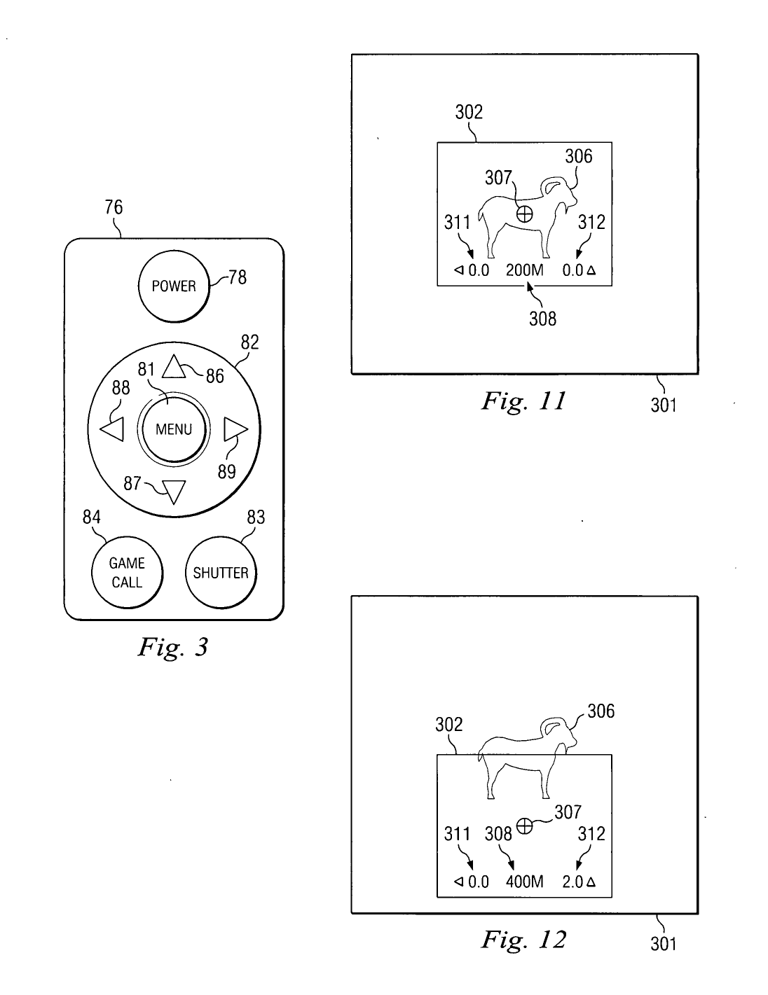

A switch panel 76 is provided on top of the housing 14, and has several manually-operable switches. FIG. 3 is a diagrammatic view of the switch panel 76, in an enlarged scale. The switch panel 76 includes a power switch 78. Manual operation of the power switch 78 causes it to toggle between on and off states, in which it respectfully provides and interrupts a flow of electrical power from the batteries 42-43 to the circuitry within the sight 10.

A manually operable MENU switch 81 is provided in the center of the switch panel 76, for a purpose discussed later. The MENU switch 81 is surrounded by an annular four-way switch 82, which is used for various purposes discussed later. Pressing any of the four sides 86-89 of the switch 82 produces a respective different electrical signal within the sight 10. The switch panel 76 also includes a SHUTTER switch 83, and a GAME CALL switch 84, both of which are discussed later.

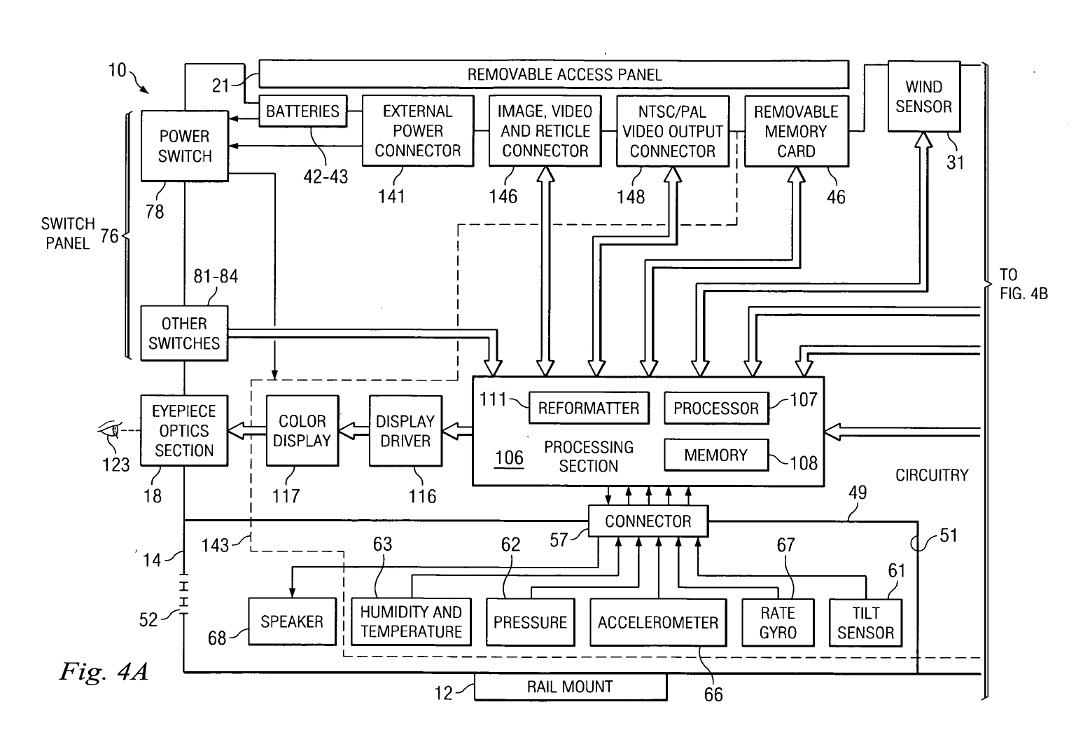

FIG. 4 is a block diagram of the rifle sight 10, and shows certain internal portions thereof which are not visible in the external views of FIGS. 1-3. Various elements which have already been discussed above are shown diagrammatically in FIG. 4, and are identified with the same reference numerals used above.

With reference to FIG. 4, the objective lens section 16 of the sight 10 has a field of view (FOV) of 5°, but it could alternatively have some other field of view. The sight 10 includes an image detector 102, and the objective lens section 16 is operable to image a remote scene or target 101 onto the image detector 102. In the disclosed embodiment, the image detector 102 is a complementary metal oxide semiconductor (CMOS) device of a known type. It has a plurality of detector elements arranged in a two-dimensional array of 2352 columns by 1728 rows. Each detector element corresponds to a respective pixel in each image produced by the image detector 102, and the image detector 102 is thus effectively a 4.1 megapixel detector. It would alternatively be possible to implement the image detector 102 using any other suitable device, including a device having a larger or smaller number of detector elements, or a device other than a CMOS image detector, such as a charge coupled device (CCD) array.

The image detector 102 produces a sequence of digital color images of the scene 101, and this sequence of images is supplied to a processing section 106. Although the image detector 102 of the disclosed embodiment produces color images, the images could alternatively be monochrome images, or black and white images. The processing section 106 includes a processor 107 of a known type, and a memory 108.

The memory 108 in FIG. 4 is a diagrammatic representation of the memory provided for the processor 107, and may include more than one type of memory. For example, the memory 108 may include a read only memory (ROM) which contains a program executed by the processor 107, as well as data that does not change during program execution. The memory 108 can also include some random access memory (RAM), in which the processor can store data that changes dynamically during program execution. The memory 108 can also include some semiconductor memory of the type commonly known as “flash” RAM, which is random access memory that will maintain information stored in it through a power loss. Memory of this type is commonly used in devices such as memory cards for digital cameras.

The processing section 106 further includes a reformatter 111 of a known type, which is capable of taking an image generated by the image detector 102 and reformatting the image to a lower resolution that is suitable for presentation on a display with a lower resolution than the image detector 102. Images processed by the reformatter 111 are supplied to a display drive circuit 116, which in turn drives a color display 117. In the enclosed embodiment, the color display 117 is a liquid crystal display (LCD) of a known type, and has a plurality of pixel elements that are arranged in a two-dimensional array of 640 columns by 480 rows. The display 117 could, however, have a larger or smaller number of pixel elements, or could be any other suitable type of display device, such as an organic light emitting diode (OLED) display, a liquid crystal on silicon (LCOS) display, or a micro-electro-mechanical system (MEMS) reflective display. It will be noted that, in the disclosed embodiment, the image detector 102 has more than thirteen times as many pixels as the display 117. This facilitates various features which are discussed later.

The eyepiece optics 18 includes optics of a known type, which permit the display 117 to be comfortably viewed by an eye 123 of a person who is using the sight in association with a firearm. In the disclosed embodiment, the eyepiece optics section 18 has a FOV of 15°, but it could alternatively have some other suitable FOV. The eyepiece optics section 18 of the disclosed embodiment could optionally be omitted for applications that allow a person to directly view the display 117 with a viewing distance greater than about 8 inches, because comfortable viewing is possible with little or no accommodation for the eye.

The above-mentioned tilt sensor 61, pressure sensor 62, temperature and humidity sensor 63, accelerometer 66, rate gyro 67 and speaker 68 are each operationally coupled to the processing section 106 through the connector 57. As mentioned above, the removable access panel 21 can be manually removed, in order to obtain access to a compartment in which it is possible to access the batteries 42-43 or the memory card 46, so that they can be replaced.

The compartment behind the access panel 21 also includes an external power connector 141, which can be coupled to an external source of power, such a converter that converts alternating current (AC) to direct current (DC). The batteries 42-43 and the external power connector are each coupled to the power switch 78. When the power switch 78 is respectively switched on and off, it respectively permits and interrupts a flow of current from the batteries 42-43 and/or the connector 141 to circuitry 143 that is disposed within the sight 10, and that requires electrical power in order to operate.

The compartment behind the access panel 21 also includes a connector 146, which is coupled to the processing section 106. The connector 146, and signals transmitted through it, conform to a well-known industry standard which is commonly referred to the Universal Serial Bus (USB) standard. However, it would be alternatively be possible to use any other suitable type of connector and communication protocol, such as a standard serial connector and communication protocol, or a standard parallel connector and communication protocol. When the connector 146 is coupled to the USB bus of a not-illustrated computer, the sight 10 automatically detects that it has been coupled to the bus, and acts as a USB mass storage slave device with respect to the USB bus. Connector 146 can be used to upload image data or video data from the sight 10 to a not-illustrated computer. In addition, the connector 146 can be used to download various types of information from a computer into the sight 10. For example, information from a computer can be downloaded through the processing section 106 into the removable memory card 46.

The compartment behind the access panel 21 also includes yet another connector 148, which can be used to transfer video information from the sight 10 to an external device. In the disclosed embodiment, the connector 148 is a standard component of the type commonly known as an RCA jack, and information transmitted through it conforms to either of two industry video standards which are commonly known as the National Television Standards Committee (NTSC) protocol, and the Phase Alternating Line (PAL) protocol. However, it would be possible to alternatively use any other suitable type of connector, and video information could be transferred according to any other suitable protocol.

It will be noted from FIG. 4 that the wind sensor 31 and the laser rangefinder 26 are each operably coupled to the processing section 106. The circuitry within the sight 10 includes a GPS circuit 156, which is coupled to the GPS antenna 28, and to the processing section 106. The GPS circuit 156 is configured to receive GPS radio signals through the GPS antenna 28, and to convert the signals in a known manner into a form that is suitable for use by the processing section 106.

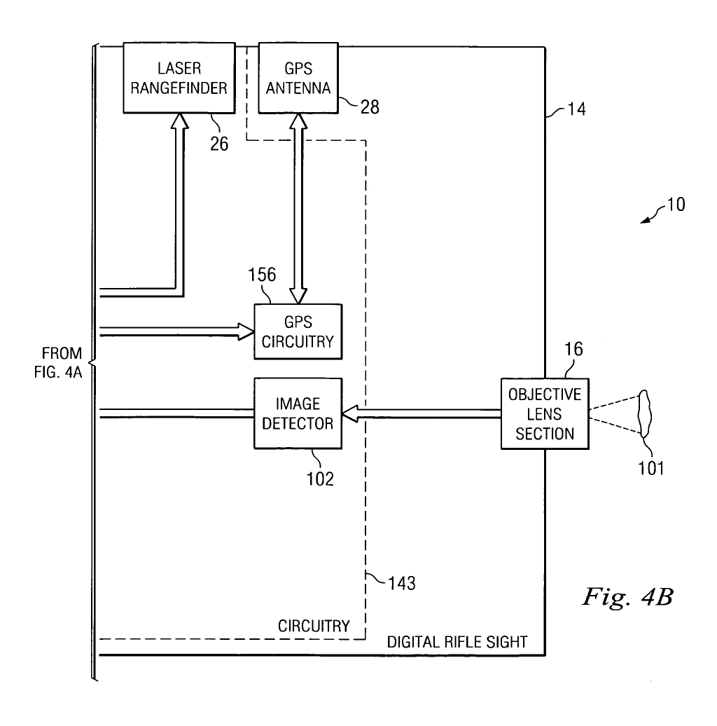

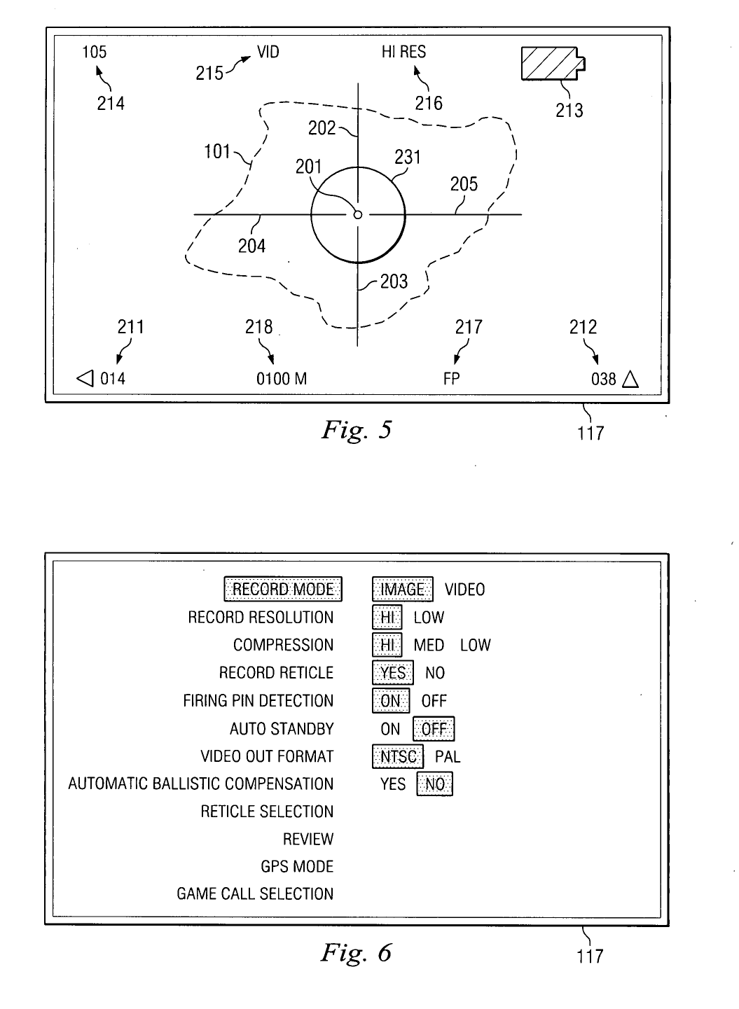

FIG. 5 is a diagrammatic view of the color display 117, as seen by the eye 123 of person looking through the eyepiece optics section 18 of the sight 10, during a normal operational mode of the sight 10. In the normal operational mode, the display 117 presents a view of the scene 101, as captured by the image detector 102 through the objective lens section 16. The scene 101 is shown diagrammatically by broken lines in FIG. 5.

The processing section 106 superimposes on the image of the scene 101 a reticle 201-205. IN FIG. 5, the reticle includes a small center circle 201, and four lines 202-205 which each extend radially with respect to the circle 201, and which are offset by intervals of 90°. The reticle 201-205 is one example of a variety of different reticles that can be used by the sight 10. In the disclosed embodiment, the sight 10 includes two predefined reticles. One is the reticle shown at 201-205, which is referred to as a “CROSSHAIR” reticle. The other predefined reticle is a standard military reticle which is identified in the sight 10 as the “MIL DOT” reticle.

In addition, electronic definitions of two custom reticles can be downloaded to the memory card 46 of the sight 10 through the USB connector 146. These custom reticles are referred to as “CUSTOM1” and “CUSTOM2”, and can have almost any configuration desired by a user. In particular, a reticle with virtually any desired configuration can be created by a user in a separate computer, or can be obtained by the user from the sight manufacturer, or from a third party through a network such as the Internet. Each such custom reticle can then be selectively electronically downloaded in digital form through the connector 146 and into the memory card 46.

Thus, at any given point in time, the sight 10 will include between two and four definitions of reticles. The user selects one of these reticle definitions, and the selected reticle is used by the sight 10 until the user selects a different reticle definition. During normal operation, the processing section 106 takes the selected reticle, and digitally superimposes it on images that will be sent to the display 117. In FIG. 5, the reticle 201-205 has been superimposed on the image, in a manner so that the reticle is centered on the display 117. However, as discussed in more detail later, there are modes where the position of the reticle on the display 117, and thus the position of the reticle relative to the image of the scene 101, may be offset from a centered position.

As shown in FIG. 5, the display 117 provides some additional information in the normal operational mode. In this regard, the lower left corner of the display 117 includes a windage or azimuth adjustment value 211, which is a positive or negative number representing a horizontal offset of the reticle 201-205 from an initial alignment or “zeroed” condition, as discussed later. Similarly, the lower right corner of the display 117 includes an elevation or pitch adjustment value 212, which is a positive or negative number representing a vertical offset of the reticle 201-205 from its initial alignment or “zeroed” condition, as discussed later. During normal operation, if no alignment adjustments have been made from the “zeroed” condition, the windage and elevation adjustment values displayed at 211 and 212 will each be zero.

The upper right corner of the display 117 has a battery charge indicator 213, which is divided into five segments, and which is used to indicate the state of the batteries 42-43. In particular, when the batteries are new, all five segments of the battery charge indicator 213 are highlighted. Then, as the batteries 42-43 become progressively discharged, the number of the segments of the battery charge indicator 213 which are highlighted will progressively decrease.

The upper left corner of the display 117 presents a count indicator 214, which relates to the fact that the processing section 106 can store single images and/or short video clips in the removable memory card 46, as discussed later. The count indicator 214 is an indication of how many additional images or video clips can be stored in the space which remains available for storing images within the memory card 46, at currently selected resolution and compression settings (which are discussed later).

The top center portion of the display 117 has a capture mode indicator 215, and a resolution indicator 216. The capture mode indicator 215 indicates which of two capture modes is currently in effect. In particular, a user can select whether a specified event will cause the sight 10 to store in the memory card 46 a single image, or a short video clip that contains several successive images. If the user has selected the video clip mode, then the indicator 215 reads “VID”. Otherwise, the indicator 215 reads “IMG”.

The user has the capability to select which of two resolutions will be used, for stored images or video clips. If the user selects the higher resolution, then the indicator 216 reads “HI RES”, and each single image or video clip image contains 1920 by 1440 pixels. On the other hand, if the user selects the low resolution, the indicator 216 reads “LO RES”, and each single image or video clip image contains 640 by 460 pixels. Alternatively, it would be possible to use different resolutions each involving some other number of pixels, and/or a different number of resolution selections.

The bottom portion of the display 117 has a firing pin detection indicator 217. The indicator 217 reflects Whether or not the sight 10 is currently enabled to detect an event where the firing pin in an associated rifle strikes a cartridge, as discussed later. When this capability is enabled, then the indicator 217 reads “FP”. Otherwise, the indicator 217 is blank.

The bottom central portion of the display 117 also includes a range indicator 218, which displays a value that the sight 10 is currently using as the distance to a target or scene 101. In FIG. 5, the letter “M” in the range indicator 218 means that the displayed numeric value is in meters. However, the distance to the target could alternatively be presented in any other desired units, such as yards.

The central portion of the display 32 has an angular error indicator 231. The indicator 231 is a circle which is larger than and concentric to the circle 201 at the center of the reticle 201-205. The diameter of the indicator 231 is increased and decreased in response to information received from the rate gyro 67. In particular, the processing section 107 monitors the output of the rate gyro 67. Typically, the user will be aiming the firearm and attempting to keep the reticle center 201 accurately centered on a portion of the scene 101 which is considered to be a target.

If the user happens to be holding the firearm very steady, the rate gyro 67 will detect little or no angular motion of the sight 10 and the firearm, or in other words little or no movement thereof transverse to the centerline of the objective lens section 16. Consequently, the processing section 107 will present the indicator 231 as a circle of relatively small diameter, in order to indicate to the user that the firearm is being relatively accurately held on the selected target. On the other hand, if the user is having difficulty holding the firearm steady, the rate gyro 67 will detect the greater degree of angular movement of the firearm and sight. Consequently, the processing section 107 will display the indicator 231 with a larger diameter, thereby indicating that the reticle center 201 is not being held on the target as accurately as would be desirable.

In the disclosed embodiment, the change in the diameter of the indicator 231 is continuous. In other words, a progressive increase in the amount of angular movement of the firearm and sight results in a progressive increase in the diameter of the indicator 231. Conversely, a progressive decrease in the amount of angular movement of the firearm and sight results in a progressive decrease in the diameter of the indicator 231. The user will thus endeavor to squeeze the trigger of the firearm at a point in time when the reticle center 201 is centered on the target, and when the indicator 231 has a relatively small diameter to indicate that the firearm is currently being held very steady.

During the normal operational mode, pressing the portions 88 or 89 (FIG. 3) of the four-way switch 82 will increase or decrease the brightness of the display 117. In addition, during the normal operational mode, pressing the portions 86 or 87 (FIG. 3) of the four-way switch 82 will produce a zoom effect. In particular, pressing one portion will increase the zoom factor, and pressing the other portion will decrease the zoom factor. In the disclosed embodiment, the zoom is continuous, and can range from 1× to 4×, but it would alternatively be possible to use a non-continuous zoom with several discrete levels, and/or some other zoom range.

As explained above, the image detector 102 has more pixels than the display 117. When the sight 10 is operating at a zoom factor of 4×, a portion is extracted from each image produced by the image detector 102, with a size of 640 by 480 pixels. This portion is then displayed on the color display 117, with each pixel from the extracted portion being mapped directly on a one-to-one basis to a respective pixel of the display 117.

When the zoom factor is at 1×, the reformatter 111 essentially takes an entire image from the image detector 102, divides the pixels of that image into mutually exclusive groups which each have 16 pixels arranged in a 4 by 4 format, averages or interpolates the 16 pixels of each group into a single calculated pixel, and then maps each of the calculated pixels to a respective corresponding pixel of the display 117. Similarly, when the zoom factor is at 3×, the reformatter 111 essentially takes an image from the image detector 102, extracts a portion having a size of about 1920 pixels by 1440 pixels, divides the pixels of this portion into mutually exclusive groups which each have 9 pixels arranged in a 3 by 3 format, averages or interpolates the 9 pixels of each group into a single calculated pixel, and then maps each of the calculated pixels to a respective corresponding pixel of the display 117. As still another example, when the zoom factor is at 2×, the reformatter 111 essentially takes an image from the image detector 102, extracts portion having a size of about 1280 pixels by 960 pixels, divides the pixels of this center portion into mutually exclusive groups which each have 4 pixels arranged in a 2 by 2 format, averages or interpolates the 4 pixels of each group into a single calculated pixel, and then maps each of the calculated pixels to a respective corresponding pixel of the display 117.

In the disclosed embodiment, the zoom from 1× to 4× is continuous. Thus, when the zoom factor is between 1× and 2×, between 2× and 3×, or between 3× and 4×, the reformatter 111 takes a corresponding portion of an image from the detector 102, and then groups, interpolates and maps the pixels of this portion into the pixels of the display 117 in a manner analogous to that discussed above. Although the zoom in the disclosed embodiment is continuous, it would alternatively be possible for the zoom factor to be moved between discrete zoom levels, such as the four discrete zoom levels of 1×, 2×, 3× and 4×.

During the normal operational mode, if the user presses the MENU button 81 (FIG. 3), the sight 10 will enter a menu mode. In this mode, information of the type shown in FIG. 5 is removed from the display 117 and is replaced with a menu, an example which is shown in FIG. 6. In FIG. 6, the left side of the display 117 presents list of menu selections, and one of these menu selections is highlighted. The right side of the display shows various permissible options for most of the menu selections. On the right side of the display, within each group of options, the currently selected option is highlighted.

In the menu mode, the user can scroll through the menu selections on the left side of the display by pressing either the portion 86 or the portion 87 of the four-way switch 82 (FIG. 3), and the currently selected menu selection is highlighted. If the highlighted selection has options shown to its right, the user can scroll through those options by pressing either the portion 88 or the portion 89 of the four-way switch 82, and the highlighting will move through these options as this scrolling occurs.

Each of the menu selections shown on the left side of FIG. 6 will now be discussed in more detail. The first menu selection is “RECORD MODE”, which permits the user to select whether a specified event will cause the sight 10 to store either a single image, or a video clip. These options are “IMAGE” or “VIDEO” in FIG. 6, and the selected option will be reflected in the capture mode indicator 215 of FIG. 5 as “IMG” or “VID”.

The second menu selection in FIG. 6 is the “RECORD RESOLUTION”. As discussed above, a user can select whether each stored image or video clip is saved with a high resolution or a low resolution, which are the respective options of “HI” and “LOW” in FIG. 6. The selected option will be reflected in the resolution indicator 216 of FIG. 5 as “HI RES” or “LO RES”.

The third menu selection in FIG. 6 is “COMPRESSION”. This allows the user to select the amount of compression that will be applied to each image or video clip that is stored in the memory card 46, which in turn affects the amount of memory space required to store that image or video clip. The sight 10 uses compression techniques of a type known in the art, such as those promulgated by the Joint Photographic Experts Group (JPEG). As shown in FIG. 6, the user can select between options of high, medium and low compression, which are respectively indicated by “HI”, “MED”, and “LOW”.

The next menu selection in FIG. 6 is the “RECORD RETICLE” selection. This option permits the user to select whether or not the currently selected reticle will be included or omitted from each saved image or video clip. The options are “YES” and “NO”. If the user selects “YES”, then the reticle will be included with the saved information. If the user selects “NO”, then the reticle will be omitted from the saved information.

The next menu selection is “FIRING PIN DETECTION”. This option allows a user to enable and disable the capability of the sight 10 to use the accelerometer 66 (FIGS. 2 and 4) to detect when a firing pin strikes a cartridge in the associated rifle. In particular, the user selects the “ON” option to enable this feature, and selects the “OFF” option to disable this feature. If this feature is enabled, then the firing pin detection indicator 217 in FIG. 5 will read “FP”, whereas if this option is disabled the indicator 217 will be blank.

When this feature is enabled, each time the sight 10 detects the shock wave caused by the firing pin striking a cartridge, the sight 10 saves in the memory card 46 either a single image or a video clip, depending on whether the “RECORD MODE” menu selection has been set to “IMAGE” or “VIDEO”, respectively. It will be recognized that, since a video clip is a series of several images, saving a video clip in the memory card 46 will take up several times the storage space that would be needed to save a single image. After saving an image or video clip, the processing section 106 adjusts the count indicator 214 presented on the display 117 (FIG. 5).

In particular, if a single image is stored while in the “IMAGE” mode, then the count indicator 214 will be decremented in order to reflect the number of additional images that can be stored in the remaining storage space at the currently selected resolution and compression. On the other hand, if a video clip is saved while in “VIDEO” mode, then the value of the indicator 214 will be reduced by an amount which corresponds to the number of images in the video clip, so that the indicator 214 will reflect the number of additional video clips that can be stored in the remaining storage space at the currently selected resolution and compression.

If the “FIRING PIN DETECTION” menu selection is set to “OFF”, the sight 10 will not detect the event of the firing pin striking a cartridge, and thus will not automatically save an image or a video clip. Instead, however, each time the user manually presses the SHUTTER switch 83 on the switch panel 76 (FIG. 3), the sight 10 will save either a single image or a video clip, depending on which option is currently selected by the user in the “RECORD MODE” menu selection.

The next menu selection in FIG. 6 is the “AUTO STANDBY” menu selection. The user can set this feature to be either “ON” or “OFF”. When this feature is turned on, and when the sight 10 is turned on, the sight 10 continuously looks for certain types of activity, including manual activation of any switch, or any output from certain sensors that is above a selected threshold, one example of which is detection by the accelerometer 66 of the firing pin striking a cartridge. If there is no detected activity during any time internal of 2.5 minutes, the sight 10 will cause the displayed reticle 201-205 to begin flashing. Then, if there is no detected activity during the next 30 seconds, the sight 10 will automatically transition to a power-saving standby state at the end of the 30 second period. In the standby state, the sight 10 monitors the switches and selected sensors and, when it detects any activity by any switch or selected sensor, automatically transitions back to the on state. Alternatively, if any activity is detected during the 30-second time interval while the reticle is flashing, the sight 10 will automatically stop flashing the reticle and will remain in the on state, rather than transitioning to the standby state.

On the other hand, if the “AUTO STANDBY” menu selection is set to the “OFF” option, then while the sight 10 is turned on, it will always remain in its fully operational mode, without regard to whether or not there is switch or sensor activity, and will not transition into or out of the power-saving standby mode.

The next menu selection in FIG. 6 is the “VIDEO OUT FORMAT” menu selection. This selection allows the user to specify whether video information which the sight 10 outputs through the connector 148 will be in “NTSC” format or “PAL” format.

The next menu selection is “AUTOMATIC BALLISTIC COMPENSATION”, which determines whether or not this feature is enabled. In particular, the user selects “YES” to enable this feature, or selects “NO” to disable this feature. The operation of the automatic ballistic compensation feature will be described in more detail later.

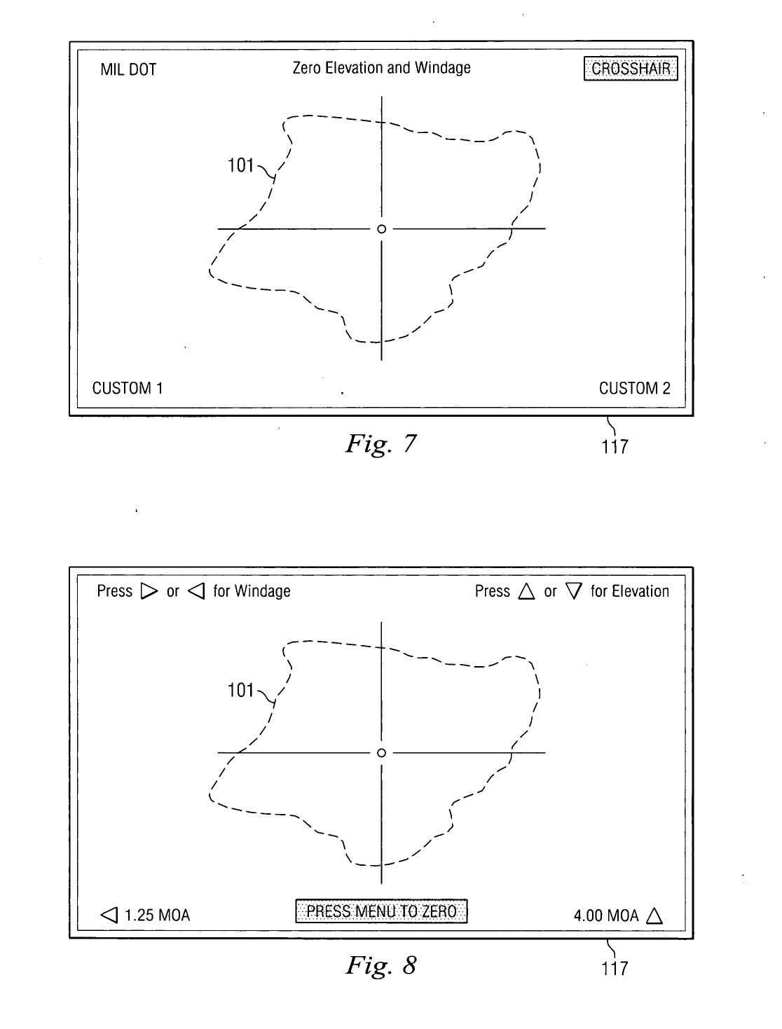

The next menu selection in FIG. 6 is “RETICLE SELECTION”. It will be noted that this menu selection does not have any options displayed to its right in FIG. 6. If the user scrolls to the “RETICLE SELECTION” menu selection, and then presses the MENU button 81 (FIG. 3), the sight 10 will replace the menu of FIG. 6 with a reticle selection screen. FIG. 7 is a diagrammatic view of the reticle selection screen.

In FIG. 7, the currently-selected reticle is shown in the center of the display 117, and the names of the two to four available reticles are each presented in a respective corner of the screen, with the name of the currently-selected reticle highlighted. The information shown in FIG. 7 is superimposed on the image of the scene 101 which is currently being detected by the image detector 102. The user can use the four-way switch 82 to switch the highlighting from the current-selected reticle to any other available reticle, in which case that reticle will be displayed. If the user then presses the “MENU” button 81, the currently-selected reticle will become the selected reticle, and the sight 10 will return to the menu screen of FIG. 6.

Alternatively, and still referring to FIG. 7, the user can also use the four-way switch 82 to highlight the option “Zero Elevation and Windage” in the top center of the display. The user can then press the MENU button 81, which will cause the display to switch from the screen of FIG. 7 to the screen which is shown diagrammatically in FIG. 8, and which is used to set elevation and windage offsets for the currently-selected reticle.

In particular, pressing the portion 88 or the portion 89 of the four-way switch 82 will move the position of the reticle leftwardly or rightwardly in relation to the image presented on the display 117, in order to adjust for windage, the amount of movement being indicated in the lower left corner of the screen. Similarly, pressing the portion 86 or the portion 87 of the four-way switch 82 will cause the reticle to move upwardly or downwardly with respect to the display 117, to serve as an elevation adjustment. The amount of the elevation adjustment is indicated in the lower right portion of the screen. At the bottom of the screen, the label “PRESS MENU TO ZERO” is always highlighted. Pressing the MENU button 81 (FIG. 3) will result in a not-illustrated confirmation request of “Zero Here?”. Selecting “NO” and pressing the MENU button 81 will discard the windage and elevation adjustments made in the screen of FIG. 8, and leave the windage and elevation adjustment at their prior values. On the other hand, selecting “YES” will save the adjustments made in the screen of FIG. 8 as the new windage and elevation “zero” values, and then the sight 10 will return directly to the operational display shown in FIG. 5 (except that the windage and elevation offsets displayed at 211 and 212 will each be zero). In FIG. 5, the reticle is displayed in the center of the screen, and the image of the scene 101 is offset relative to the reticle by the amounts of the selected windage and elevation offsets.

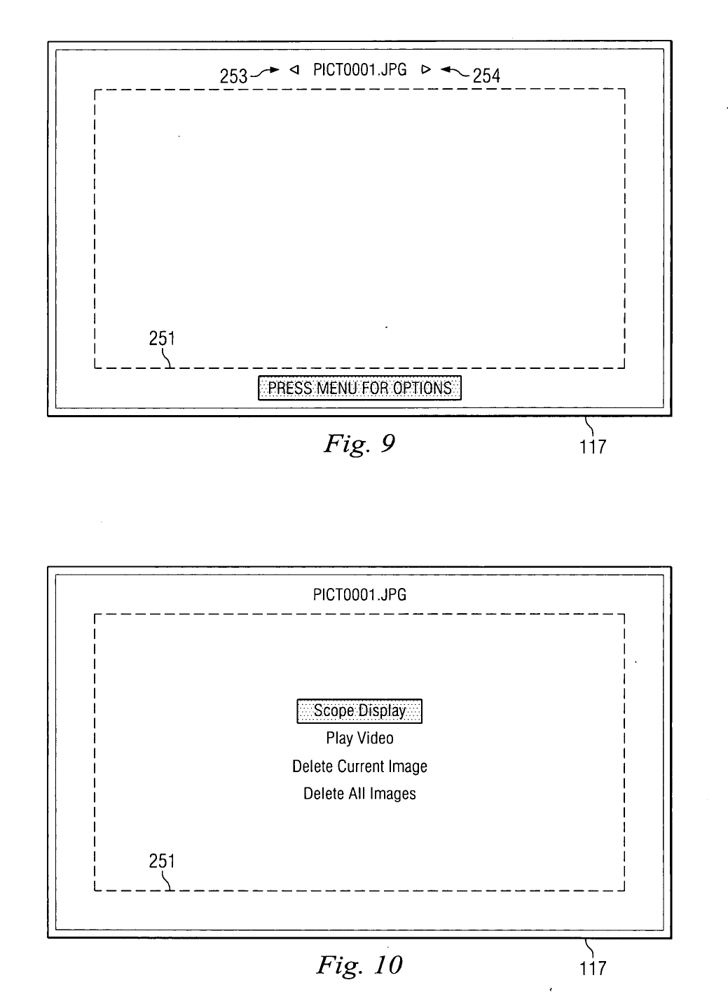

Referring again to the menu shown in FIG. 6, the next menu section is the “REVIEW” selection. The user can use this selection to review the images or video clips which have been stored in the memory card 46 of the sight 10. In particular, if the user selects the “REVIEW” selection and then presses the “MENU” button 81, the menu of FIG. 6 will be replaced with an image display screen, which is shown diagrammatically in FIG. 9.

Referring to FIG. 9, if there are no saved files with images or video clips, then the not-illustrated phrase “No Images Saved” will appear on the display. Otherwise, the image of the last saved file will be presented in the center of the display 117, as indicated diagrammatically at 251. If the last saved file contains a video clip rather than a single image, then the first image or, frame of the video clip will be displayed. The name of the last file is shown in the top center of the display. If there is more than one saved file, then the trianglar icons 253 and 254 will be presented on opposite sides of the file name, in order to indicate that the portions 88 and 89 of the four-way switch 82 can be used scroll successively through the files in either a forward or reverse direction.

A label “PRESS MENU FOR OPTIONS” appears at the bottom of the screen of FIG. 9. If the user presses the menu button 81, an options menu is overlaid on the image 251, as shown diagrammatically in FIG. 10. The user can then use the portions 86 and 87 of the four-way switch 82 to scroll through and highlight one of these menu options, and can press the MENU button 81 in order to select the highlighted option. The first option is “SCOPE DISPLAY”, which immediately returns the sight 10 to its normal operational mode, where the display 117 presents the screen of FIG. 5. In FIG. 10, the second option is “PLAY VIDEO”, which will appear only if the file under review is a video clip, and which will cause the video clip to be played for the user. When the video clip completes, the sight 10 will return to the screen of FIG. 9, and will again display the first image of the current video clip.

The third option in the menu of FIG. 10 is “DELETE CURRENT IMAGE”. This permits the user to delete the file containing the current image or video clip. If the user selects this option, the sight 10 will present on the display 117 a not-illustrated prompt, asking the user to confirm that the current file is to be deleted. The sight 10 will then delete the file if the user confirms that it is to be deleted.

The final selection in the menu of FIG. 10 is “DELETE ALL IMAGES”. If the user selects this option, the sight 10 will present on the display 117 a not-illustrated prompt, asking the user to confirm that all saved files are to be deleted. The sight 10 will then delete all such files if the user confirms that they are to be deleted. When the user selects either of the last two options in the menu of FIG. 10, and regardless of whether the user does or does not actually delete one or more files, the sight 10 will return the user to the screen of FIG. 9, showing either the current image if it was not deleted, or the next available image which has not been deleted.

Referring again to FIG. 6, the next available selection in the illustrated menu is the “GPS Mode” selection. If the user highlights this selection and then presses the “MENU” button 81, the sight 10 will use information received through the GPS antenna 28 and the GPS circuitry 156 to determine the current location of the sight 10 on the surface of the earth. The sight 10 will then present on the display 117 an appropriate portion of some map data stored in the memory card 46 of the sight 10, and will superimpose an icon on this map to indicate the current location of the sight 10. This is carried out using techniques which are known in the art of GPS devices. The map data used for this GPS function can be downloaded into the memory card 46 of the sight 10 through the connector 146 (FIG. 4). The user can press the MENU button 81 to exit the GPS mode and return to the normal operational mode, in which the display 117 presents a screen of the type shown in FIG. 5.

Referring again to FIG. 6, the final menu selection is the “GAME CALL” selection. The user can download into the memory card 46 through the connector 146 one or more files, which each contain information representing an audio sound, typically a respective animal sound of a type commonly known as a game call. In some cases this may be a sound made by one type of animal, such as a mating call, which will tend to attract other animals of the same type. In other cases, this may be a sound made by one type of animal, such as a cry of distress, which would tend to attract a different type of animal that is a predator of the first type.

If the user selects the “GAME CALL” selection in the menu of FIG. 6, and then presses the MENU button 81, the sight 10 will replace the menu of FIG. 6 with a not-illustrated menu that lists each of the game call files that the user has downloaded into the sight 10. The user can then use the four-way switch 82 to scroll among and select one of these game calls, and then can press the MENU button 81 in order to select this particular game call and return to the sight 10 to its normal operational mode, in which the display 117 presents a screen of the type shown in FIG. 5. Thereafter, whenever the user presses the GAME CALL button 84 (FIG. 3), the circuitry within the sight 10 uses the speaker 68 to produce the audio sound of the currently-selected game call.

As mentioned above, one of the selections in the menu of FIG. 6 is the “AUTOMATIC BALLISTIC COMPENSATION” selection. This feature can also be referred to as automatic aimpoint adjustment. Before explaining this feature in detail, some background information is appropriate.

The trajectory of a bullet or other projectile is determined by the laws of motion. A bullet exits the barrel of a firearm along the bore line, with a muzzle velocity which is determined by factors such as characteristics of the rifle and characteristics of the cartridge. The characteristics of a cartridge can include factors such as the amount of powder in the cartridge. Once the bullet has left the rifle, external forces that act on the bullet can cause changes in the trajectory of the bullet's flight. The primary forces that influence the bullet are gravity, wind and drag.

In a vacuum, when a bullet is fired horizontally, the horizontal velocity component encounters no resistance and remains constant, whereas the constant force of gravity will cause the bullet to drop vertically, with the overall effect that the bullet follows a well-known parabolic path. Outside a vacuum, however, air produces drag forces that slow both the horizontal and vertical components of the velocity of the bullet. As the velocity decreases, there is an increase in the time of flight needed to reach a given range. The longer flight time allows a further degree of drop due to gravity. Wind forces can also influence the trajectory of the bullet.

Focusing in more detail on drag, the drag forces on a bullet are due to differences in pressure acting on the surface of the bullet, and air friction along the surface of the bullet. These forces are dependent on a number of factors, including the bullet shape and velocity, and the density of the ambient atmosphere. Changes in temperature, pressure or humidity will change the density of the atmosphere from standard sea-level conditions, which in turn can affect the drag forces exerted on a bullet. For example, the density of the atmosphere is lower at higher temperatures, causing a decrease in drag. As another example, the density of the atmosphere is higher at higher barometric pressures, causing an increase in drag.

The coefficient of drag as function of bullet velocity has been determined experimentally for standard bullets with respect to different form factors at standard sea-level atmospheric conditions. Mathematical models have been developed that predict velocity, retardation for the standard bullet from factors due to drag. Ammunition manufacturers test their bullets, and publish ballistic coefficients that relate the velocity retardation of their bullets to that of standard bullets. Computer programs have been developed that predict the trajectory of a bullet based on various factors, such as the initial muzzle velocity, the ballistic coefficient, gravity, and prevailing environmental conditions such as wind, pressure, temperature and humidity. One example of a software program that is capable of performing these types of calculations is the program named “Load from a Disk”, which is available commercially from W. Square Enterprises of Houston, Tex.

As discussed above, the disclosed rifle sight 10 includes various sensors which provide information relevant to bullet trajectories. The wind sensor 31 provides information regarding the direction and speed of any prevailing wind, the tilt sensor 61 provides information regarding the degree of tilt of the rifle about two different axes, the sensor 62 provides information about ambient barometric pressure, the sensor provides information about ambient temperature and humidity, and the rangefinder 26 provides information about the actual range to the target.

In addition, the memory 108 of the sight 10 stores tables and/or other ballistic data which are relevant to the calculation of trajectories. In the disclosed embodiment, and for simplicity in explaining the present invention, it is assumed that the user has downloaded tables or other ballistic data which are specific to the particular bullets and rifle that are being used by the user. Alternatively, however, it would be possible for the sight 10 to include certain standard data, and to permit the user to use a variation of the above-described menuing system to select coefficient information from among two or more types of bullets. The program executed by the processor 107 includes equations or other intelligence of a known type, which permit the processor 107 to calculate bullet trajectories from the information available to it, including not only the data stored in its memory, but also the information which it is currently receiving from the various different sensors of the sight 10.

When any sight is first mounted on any firearm, it must be initially aligned to the firearm, so that a bullet will precisely strike a target at a known range when the aiming reticle is positioned on the target. This is normally accomplished through a manual process of trial and error. For example, a person may shoot one or more bullets at a target which is a known distance away, identify the extent to which the bullets strike the target at locations offset from the location at which the person was aiming, and then adjust the alignment of the sight in relation to the firearm in a manner intended to eliminate the offset. This sequence of steps is repeated in an iterative manner, until bullets are striking the target at substantially the same location where the person is aiming.

Once a pre-existing sight has been aligned or “zeroed” in this manner for the known range, a person who thereafter uses the firearm and sight must make allowances both mentally and visually for a variety of factors that can differ from the conditions which existed during the initial alignment, including a greater or lesser range, and various atmospheric conditions that can affect drag. In contrast, when the “AUTOMATIC BALLISTIC COMPENSATION” selection in the menu of FIG. 6 is enabled, the sight 10 will automatically use its sensors and its stored ballistic data to accurately calculate the trajectory which will be followed by a bullet under the current conditions, and will then calculate an appropriate adjustment needed in the aimpoint. The sight 10 will then automatically adjust the relative position of the reticle and the scene as presented on the display 117 so that, when the user centers the reticle on the target, the bullet can be expected to hit the target without any need for the user to manually and visually attempt to offset the reticle in relation to the target, in an attempt to compensate for the various ambient conditions.

Some specific examples will now be discussed in order to facilitate an understanding of how the sight 10 can effect automatic ballistic compensation when this feature is enabled, or in other words automatic aimpoint adjustment. First, it will be assumed that the automatic ballistic compensation feature is not enabled. In this regard, FIG. 11 is a diagrammatic view, in which reference numeral 301 represents the entire image detected by the image detector 102 (FIG. 4), and reference numeral 302 represents the portion of this image which is currently being presented on the color display 117. As discussed earlier, the sight 10 has the capability to select a specific portion of the image 301 for presentation on the display 117. In FIG. 11, the display 117 shows an image, that includes a target 306, which is an animal such as a ram. The currently-selected reticle 307 is superimposed on the displayed image.

The display indicates at 308 that the sight 10 has been zeroed for a range of 200 meters, and indicates at 311 and 312 that the sight is using the zeroed setting for both windage and elevation. Assume, however, that the actual distance to the target 306 is not 200 meters, but 400 meters. Since the automatic ballistic compensation feature is not enabled, if a person using the rifle simply centers the reticle 307 on the target 306, as shown in FIG. 11, the bullet will fall short of the target.

Now assume the same situation, but with the automatic ballistic compensation feature enabled. The sight 10 will use its various sensors to determine the current temperature, pressure, humidity, wind speed, wind direction, and range to target, and the tilt of the sight and rifle in two dimensions. Then, using this information in combination with known equations and the stored ballistic information for the particular type of bullet and rifle which are being used, the sight 10 will calculate a trajectory to the target 306, and display the reticle 307 at the expected target impact point.

In this regard, FIG. 12 is a diagrammatic view similar to FIG. 11, but showing that the sight 10 has automatically shifted the displayed image 302 relative to the detected image 301, so that the reticle 307 identifies the expected impact point of the bullet within the detected scene. It will be noted that the indicator 308 has been automatically adjusted to show that the actual range to the target is 400 meters, and the indicator 312 shows that the elevation setting has been automatically adjusted to compensate for the difference between the calibrated range and the actual range.

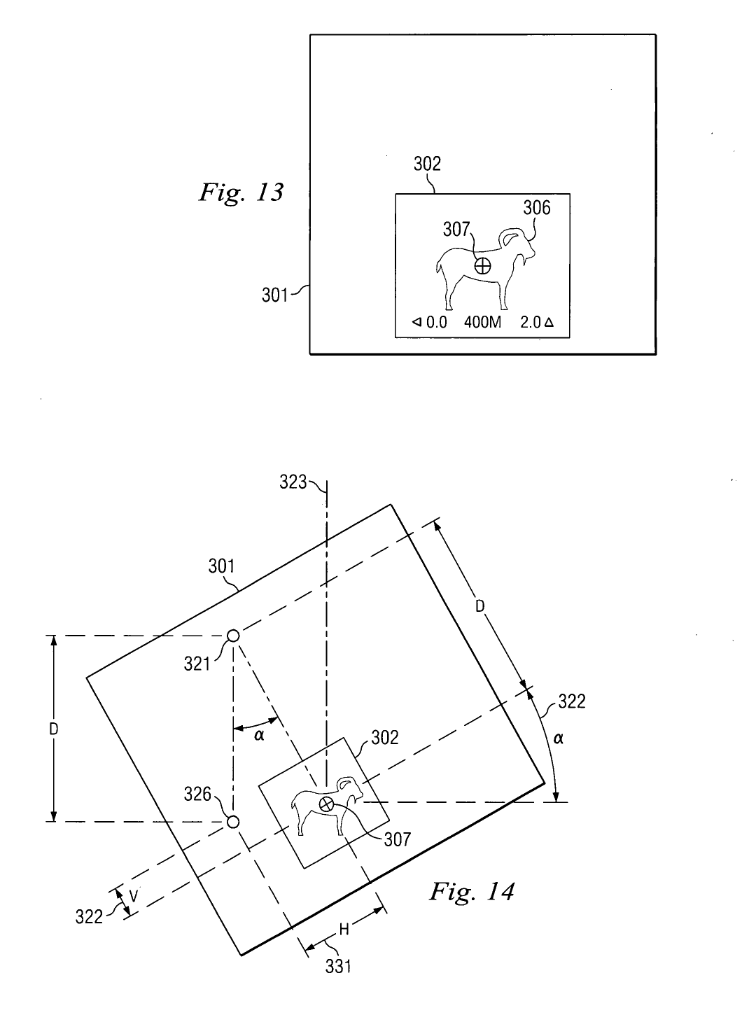

If the person using the rifle and sight now raises the outer end of the barrel of the rifle, the target 306 will move downwardly within the detected image 301, until the reticle 307 is centered on the target 306. In this regard, FIG. 13 is a diagrammatic view similar to FIG. 12, but showing how the reticle 307 has been centered on the target. The expected impact point of the bullet is now centered on the target 306, and the bullet should accurately hit the target. It will be noted that the person using the rifle and sight does not need to try to make any mental estimate of a reticle offset intended to compensate for various factors such as ambient temperature, pressure, humidity, wind and range to target, and does not need to visually offset the reticle 307 from the actual target 306 by this estimated amount.

As another example, assume that the person using the rifle and sight finds it necessary when taking aim to tilt the rifle and sight a few degrees about the longitudinal axis of the barrel. FIG. 14 is a diagrammatic view showing the detected image 301 under these circumstances, and showing the portion 302 of this image which would be displayed when automatic ballistic compensation is disabled. In FIG. 14, 321 represents a bore line of the rifle, 322 represents the angle α of tilt or roll of the rifle and sight about a longitudinal axis, 323 represents the direction of the force of gravity, and 326 represents the expected point of actual impact of the bullet within the detected scene. It will be noted that, in this particular example, the expected point of impact is not even within the displayed portion 302 of the detected image 301. To try to hit the target, a person using the rifle and sight would have to make a mental estimate of the amount of reticle offset needed, and then try to visually offset the reticle by this estimated amount, which would be very difficult under these circumstances.

Now assume that the person using the sight 10 enables the automatic ballistic compensation feature. The tilt sensor 61 (FIG. 4) will provide the sight 10 with information which includes the tilt or roll angle 322. Using standard trigonometric relationships, the sight 10 can calculate the horizontal and vertical offsets 331 and 332 which are needed in order to reposition the portion 302 relative to the image 301 so that the reticle 307 will be centered over the expected point of bullet impact 326.

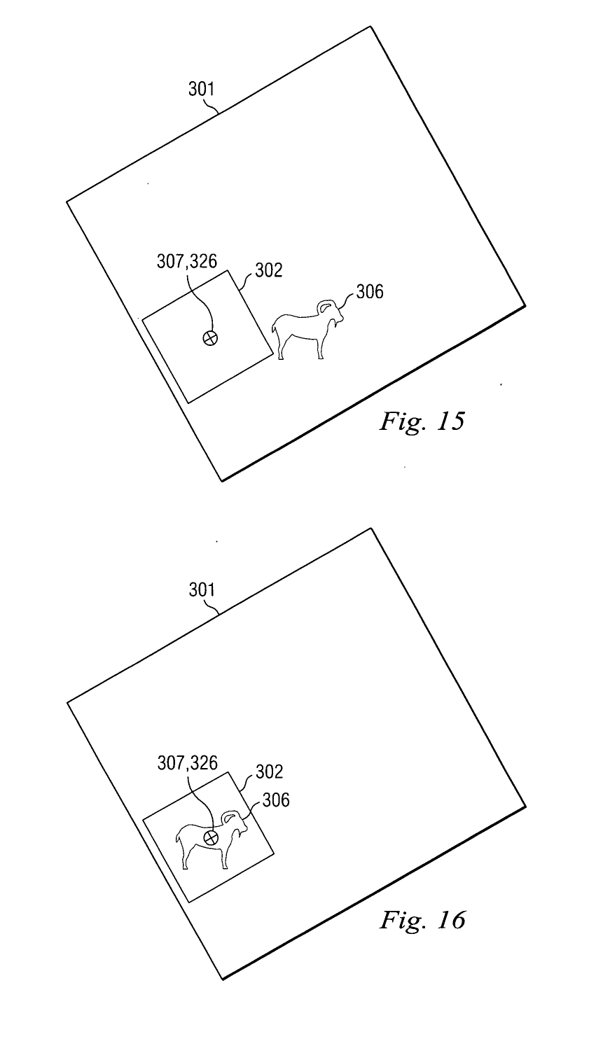

FIG. 15 is a diagrammatic view similar to FIG. 14, but showing how the sight 10 has automatically repositioned the displayed portion 302 of the detected image 301 by the offsets 331 and 332 (FIG. 14), so that the reticle 307 is now centered over the expected impact point 326. The person using the rifle and sight can then adjust the position of the rifle so that the target 306 moves within the image 301 until the reticle 307 is centered on the target 306. FIG. 16 is a diagrammatic view similar to FIG. 15, but showing how the user has centered the adjusted reticle 307 on the target 306. The expected impact point of the bullet now coincides with the target, and the bullet can be expected to accurately hit the target. Thus, with the automatic aimpoint adjustment capability provided by the automatic ballistic compensation feature, the person using the rifle and sight can position the reticle directly on the target without any need to try to mentally and visually offset the reticle from the target by an estimated amount that is needed to compensate for a variety of different environmental factors.

When the sight 10 is in its normal operational mode corresponding to the screen of FIG. 5, quickly pressing the MENU button 81 twice, or in other words “double-clicking” this button, will allow the person using the sight to effect some manual adjustments using the four-way switch 82 (FIG. 3). The type of manual adjustment which occurs will depend on whether or not the automatic ballistic compensation feature is currently enabled.

If the automatic ballistic compensation feature is not currently enabled, then the operation of the four-way switch 82 will effect a temporary adjustment in the offset on the display 117 between the selected reticle 201-205 and the displayed image. In particular, pressing the portions 86 or 87 of the four-way switch 82 will effect relative vertical movement of the reticle 201-205 and the displayed image, and the value of the elevation indicator 212 will be adjusted to reflect the amount of the manual adjustment. Similarly, pressing the portions 88 or 89 of the four-way switch 82 will effect relative horizontal movement of the reticle 201-205 and the displayed image, and the value of the windage indicator 211 will be adjusted to reflect the amount of this manual adjustment. When the user presses the MENU button 81 again, the sight 10 will discard these temporary adjustments and return to its normal operational, mode, using the elevation and windage settings that were in effect before the MENU button was double-clicked. In particular, the windage and elevation adjustments 211 and 212 will each display a value of zero, and the range indicator 308 will display the range for which the firearm and sight are zeroed.

On the other hand, if the automatic ballistic compensation feature is enabled when the MENU button 81 is double-clicked, then operation of the four-way switch will effect a temporary adjustment in the range setting used for the automatic ballistic compensation. In particular, pressing the portions 86 or 87 of the four-way switch 82 will manually increase or decrease the range setting, and the manual value will be used in place of the range information from the rangefinder 26 for purposes of carrying out automatic ballistic compensation. As the range is manually adjusted, the range indicator 218 (FIG. 5) will be adjusted to show the current value of the manually specified range. When the user presses the MENU button 81 again, the sight 10 will discard this manually entered range value, and will return to its normal operational mode, using the range information provided by the rangefinder 26.

Referring again to FIG. 11, a further feature of the sight 10 is that it automatically adjusts one or more characteristics of the reticle 307 in order to improve the visibility of the reticle. In the disclosed embodiment, if the reticle 307 is centered on the target 306, and if the target 306 is a relatively dark color, the sight 10 will automatically select and use a complementary light color for the reticle 307, such that the reticle 307 is highly visible. Conversely, if the reticle 307 is centered on a target 306 which is a relatively light color, the sight 10 will automatically select and use for the reticle 307 a complementary dark color, so that the reticle 307 is highly visible. In a similar manner, it would alternatively be possible for the sight 10 to adjust one or more of a variety of other characteristics of the reticle 307, including but not limited to the size, brightness and/or shape of the reticle.

Still another feature is that the sight 10 uses techniques that can improve the visibility of a target. In this regard, and with reference to FIG. 11, when the reticle 307 is centered on an object such as a target 306, the sight 10 uses known image processing and image enhancement techniques to differentiate the portion of the detected image which is the target 306 from other portions of the detected image which are immediately adjacent the target 306, in particular by adjusting one or more characteristics in the displayed image such as color, brightness and/or contrast, in order to make the target 306 more highly visible in relation to its background.

In addition, the sight 10 has the capability to compare each successive pair of detected images of the scene, in order to identify changing pixels that can represent motion. Thus, for example, if an object or animal which is a prospective target 306 is moving within the detected scene, the sight 10 can use known image analysis techniques to detect this motion, and can then adjust one or more characteristics such as color, brightness and/or contrast, in order to highlight the detected motion in relation to other portions of the detected scene that do not involve motion.

The present invention provides a number of advantages. One such advantage results from the capability to take information representing one or more current conditions, to use this information to automatically determine an expected point of impact for a projectile, and to then automatically adjust a reticle or aimpoint so that it coincides with the expected point of bullet impact. A related advantage is realized where some or all of the information about current conditions is obtained automatically using one or more sensors.

A further advantage is realized where a firearm sight has the capability to automatically adjust at least one characteristic of a reticle in relation to a scene on which it is superimposed, for example by adjusting one or more of the color, shape, size, and/or brightness of the reticle as a function of the portion of the image on which the reticle is currently superimposed.

Still another advantage results from the provision of capability to use image processing and enhancement techniques to improve the visibility of one portion of a scene in relation to the portions surrounding it. For example, the portion of a scene on which a reticle is centered can be enhanced in relation to other adjacent portions. Alternatively, successive detected images can be compared in order to detect pixel changes which represent motion, and the portion of the scene which corresponds to detected motion can then be highlighted.

Still another advantage results from the provision of the capability in a rifle sight to receive global positioning system (GPS) signals, and to display a portion of a map with an indication on the map of the current location of the firearm sight. A related advantage is realized by the capability to download selected map information into the rifle sight.

Another advantage is realized where a rifle sight has the capability to selectively generate an audio sound, such as that commonly known as a game call. A further advantage is realized where a set of one or more game calls can be selected in a computer and then downloaded into the rifle sight.

Although one embodiment has been illustrated and described in detail, it will be understood that various substitutions and alterations are possible without departing the spirit and scope of the present invention, as defined by the following claims.

1-12. (canceled)

13. An apparatus comprising:
a firearm sight, said firearm sight including:
a firearm sight housing;
an eyepiece optics section disposed within said firearm sight housing;
a digital display which permits a user to view a digital image of a scene in association with a reticle, said digital display being disposed within said firearm sight housing in such a manner that said user may view said digital image through said eyepiece optics section; and
a processing section configured to adjust said digital image to distinguish a first portion of said image which is substantially aligned with said reticle from a second portion of said image which is adjacent said first portion thereof, said processing section being disposed within said firearm sight housing.

14. An apparatus according to claim 13, wherein said processing section effects said adjusting of said digital image by adjusting the contrast between said first and second portions of said image.

15-18. (canceled)

19. An apparatus comprising:
a firearm sight which includes:
a receiver that receives electromagnetic signals;
a circuit responsive to said received electromagnetic signals for determining a position of said firearm sight on the surface of the earth; and
a display, said circuit presenting information on said display representing the position of said firearm sight on the surface of the earth.

20. An apparatus according to claim 19, wherein said receiver is a global positioning system (GPS) receiver, and said electromagnetic signals received by said receiver are GPS signals.

21. An apparatus according to claim 19,
wherein said circuit includes map information;
wherein said information presented by said circuit on said display includes a selected portion of said map information; and
wherein said circuit effects said presentation on said display of said firearm sight at an appropriate location on said selected portion of said map information.

22-32. (canceled)

33. A method comprising:
presenting for a user on a digital display disposed within a firearm sight a digital image of a scene in association with a reticle, said presenting including passing said digital image through an eyepiece optics section to said user's eye; and
adjusting, with a processing section disposed within said firearm sight, said digital image to distinguish a first portion of said image which is substantially aligned with said reticle from a second portion of said image which is adjacent said first portion thereof.

34. A method according to claim 33, wherein said adjusting includes adjusting the contrast between said first and second portions of said image.

35-37. (canceled)

38. A method of operating a firearm sight having a display, comprising:
receiving electromagnetic signals;
determining in response to said received electromagnetic signals a position of said firearm sight on the surface of the earth; and
presenting information on said display which represents the position of said firearm sight on the surface of the earth.

39. A method according to claim 38, wherein said receiving is carried out using global positioning system (GPS) signal as said electromagnetic signals.

40. A method according to claim 38,
including providing map information within said firearm sight; and
wherein said presenting includes presenting on said display a selected portion of said map information with an indication on said selected map information of said position of said firearm sight on the surface of the earth.

41. An apparatus according to claim 13, wherein said firearm sight further includes:
a receiver configured to receive electromagnetic signals; and
a circuit disposed within said firearm sight housing and responsive to said received electromagnetic signals for determining a position of said firearm sight on the surface of the earth, said circuit configured to present information on said digital display representing the position of said firearm sight on the surface of the earth.

42. An apparatus according to claim 41, wherein said receiver is a global positioning system (GPS) receiver, and said electromagnetic signals received by said receiver are GPS signals.

43. An apparatus according to claim 41,
wherein said circuit includes map information;
wherein said information presented by said circuit on said display includes a selected portion of said map information; and
wherein said circuit effects said presentation on said display of said firearm sight at an appropriate location on said selected portion of said map information.

44. A method according to claim 33, further including:
receiving electromagnetic signals;
determining in response to said received electromagnetic signals a position of said firearm sight on the surface of the earth; and
presenting information on said digital display which represents the position of said firearm sight on the surface of the earth.

45. A method according to claim 44, wherein said receiving is carried out using global positioning system (GPS) signal as said electromagnetic signals.

46. A method according to claim 44,
including providing map information within said firearm sight; and
wherein said presenting includes presenting on said digital display a selected portion of said map information with an indication on said selected map information of said position of said firearm sight on the surface of the earth.
